(19) United States
(12) Patent Application Publication
(10) Pub. No.: US 2012/0288667 A1
(43) Pub. Date: Nov. 15, 2012

(54) Metallized Structure Layer For a Window Arrangement

(75) Inventors: Anders Stjernman, Lindome (SE); Göran N. Klang, Enskede (SE)

(73) Assignee: Telefonaktiebolaget L M Ericsson (publ), Stockholm (SE)

(21) Appl. No.: 13/175,322

(22) Filed: Jul. 1, 2011

Related U.S. Application Data
(63) Continuation of application No. PCT/EP2011/060978, filed on Jun. 30, 2011.
(60) Provisional application No. 61/485,329, filed on May 12, 2011.
(60) Provisional application No. 61/485,329, filed on May 12, 2011.

(51) Int. Cl. B32B 3/10; B60J 3/00

(52) U.S. Cl. 428/131

(57) ABSTRACT

A metallized structure layer having a first main side and a second main side. The metallized structure layer is arranged to be mounted such that the first main side faces a second base main side of a transparent base plate layer, where said main sides are parallel to each other and at least partly overlap. The metallized structure layer comprises a plurality of metallic areas separated by a coherent aperture forming a grid in which the metallic areas are positioned. The present invention also relates to a window arrangement comprising a metallized structure layer according to the above.

### CROSS REFERENCE TO RELATED APPLICATIONS

This application is a continuation of international application PCT/EP2011/060978, filed on Jun. 30, 2011, which claims the benefit of provisional patent application No. 61/485,329, filed on May 12, 2011; this application also claims the benefit of provisional patent application No. 61/485,329, filed on May 12, 2011. The contents of the above identified references are incorporated by reference herein.

### TECHNICAL FIELD

Embodiments relate to a metallized structure layer having a first main side and a second main side. In some embodiments, the metallized structure layer is arranged to be mounted such that the first main side faces a base main side of a transparent base plate layer. In some embodiments, the main sides are parallel to each other and at least partly overlap.

Another embodiments relates to a window arrangement comprising a transparent base plate layer and a metallized structure layer. The transparent base plate layer has a first base main side and a second base main side, and the metallized structure layer has a first main side and a second main side. In some embodiments, the transparent base plate layer and the metallized structure layer are mounted such that the second base main side of the base plate layer faces the first main side of the metallized structure layer. In some embodiments, the main sides are parallel to each other and at least partly overlap.

### BACKGROUND

Reducing the use of energy is an important goal in today's society. This goal is driven not only by the desire to save money, but also by the increasing awareness of potential adverse, long-term environmental effects caused by high energy consumption levels. Political actions, as well as changes in consumer behavior and demand, have caused businesses and individuals to focus on developing energy-saving products.

In sectors associated with high energy use, such as transportation and indoor climate, businesses are developing highly efficient engines with low fuel consumption and low CO2 emissions. Recently, use of metallized windows, which are constituted by glass to which a metallic layer in the form of a metallized window film has been applied, have become more and more frequent as a means to reduce energy consumption of vehicles equipped with climate control systems as well as office buildings and other structures that require cooling.

Typically, a metallized window is created by adhering a multi-layer film that comprises layers of dye, UV protection and metallic films to a glass base layer, thereby causing the resulting window structure to either reflect or adsorb heat in the form of infrared radiation.

The use of traditional metallized windows has the drawback of reducing the strength of microwave signals used by, for example, mobile communication systems. In vehicles with body made of metal, and also in buildings covered by metal, this may lead to drastically lowered performance, and even blocking, of the microwave signals that are intended to be transmitted or received by devices located inside the vehicle or building. The reason for this is that the vehicle or building essentially is transformed into a Faraday cage.

A traditional way of reducing the negative effect that metallized windows has on mobile communication systems is to use repeaters or relays connected to antennas outside the vehicle or building. This solution effectively creates an isolated cell inside the vehicle or building. In practice, due to the extra hardware needed, this can be a rather costly and expensive solution, particularly when a wide bandwidth needs to be repeated or several systems, possibly with different air interfaces, are to be relayed.

Moreover, it is possible that severe interference problems can occur when a window or door is opened, which effectively removes the isolation required by the repeater or relay.

A metallic layer in which a periodic structure of apertures is formed may allow specific frequencies to penetrate the metallic layer while blocking other unwanted frequencies. Such a metallic layer is known as a Frequency Selective Structure (FSS).

Most wireless systems for mobile communication today operate at frequencies below 10 GHz. Thus, it is desirable to make the windows transparent for all frequencies from a few MHz up to 10 GHz, but block or attenuate certain frequencies above 10 GHz, for example infrared frequencies. It is extremely hard to design FSS aperture elements with such a bandwidth.

U.S. Pat. No. 5,867,129 discloses an automobile windshield covered with a transparent electrically conducting layer, on which slots are provided. Microwave radiation is absorbed by the conducting layer to again be retransmitted by the slots which act as antennas. However, this kind of structure is relatively narrow-banded, and has a relatively high damping of the passing microwave radiation.

Thus, there is a need for an improved metallized window structure which provides low damping for passing broad-banded microwave radiation.

### SUMMARY

An object of the present invention is to provide a metallized window structure which provides low damping for passing broad-banded microwave radiation in comparison with prior art.

This object is achieved by means of a metallized structure layer having a first main side and a second main side. The metallized structure layer is arranged to be mounted such that the first main side faces a second base main side of a transparent base plate layer, where said main sides are parallel to each other and at least partly overlap. The metallized structure layer comprises a plurality of metallic areas separated by a coherent aperture forming a grid in which the metallic areas are positioned.

The object is also achieved by means of a window arrangement comprising a transparent base plate layer and a metallized structure layer. The base plate layer has a first base main side and a second base main side, and the metallized structure layer has a first main side and a second main side. The transparent base plate layer and the metallized structure layer are mounted such that the second base main side of the base plate layer faces the first main side of the metallized structure layer. The main sides are parallel to each other and at least partly overlap. The metallized structure layer comprises a plurality of metallic areas separated by a coherent aperture forming a grid in which the metallic areas are positioned.

According to an example, the metallized structure layer comprises a carrier onto which the metallic areas are deposited. The metallic areas may be made by a metallic oxide and are preferably transparent.

According to another example, the metallic areas have such dimensions that they are resonant for a certain frequency of incident electromagnetic radiation, such that they at least partially are transparent for incident electromagnetic radiation having a frequency below said certain frequency.

According to another example, the metallic areas are arranged in a two-dimensional array pattern with rows and columns, adjacent metallic areas being separated by a first distance in a first direction and by a second distance in a second direction, the first direction and second direction being mutually perpendicular.

Other examples are disclosed in the dependent claims.

A number of advantages is obtained by means of the present invention. For example: (a) the need for a more complicated system requiring repeaters and/or relays is eliminated, and (b) the need for a precise design of the metallic structure layer is eliminated. A broadband functionality with relatively low damping for microwave radiation is obtained.

### BRIEF DESCRIPTION OF THE DRAWINGS

The present invention will now be described more in detail with reference to the appended drawings, where:

FIG. 1 shows a schematic exploded perspective view of a window arrangement according to the present invention.

FIG. 2 shows a schematic exploded side view of a window arrangement according to the present invention.

FIG. 3 shows a schematic front view of a part of a metal pattern according to an example of the present invention.

### DETAILED DESCRIPTION

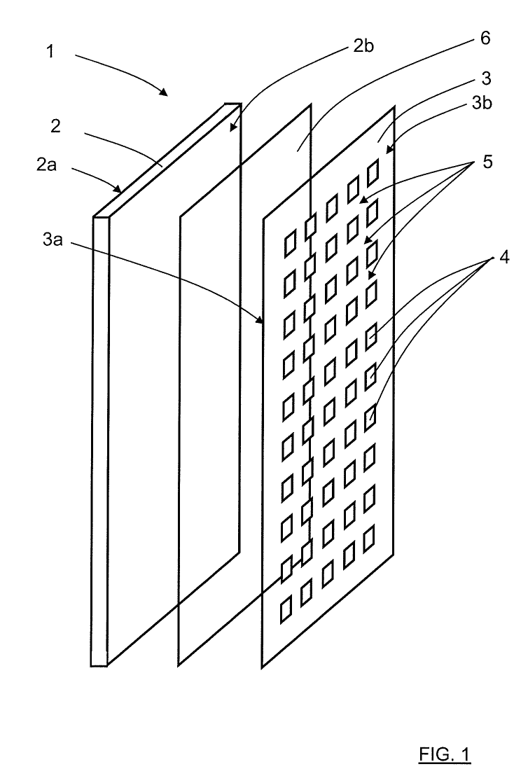

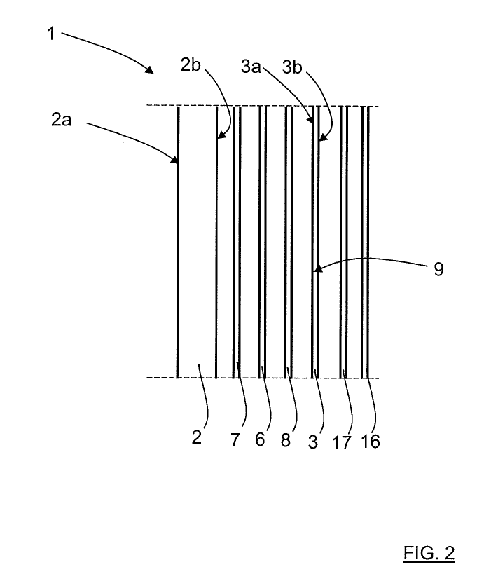

With reference to FIG. 1 and FIG. 2, there is a window arrangement 1 comprising a transparent base plate layer 2, a UV blocking layer 6, a metallized structure layer 3 and a protective layer 16, the protective layer not being shown in FIG. 1 for reasons of clarity. The base plate layer 2 has a first base main side 2a and a second base main side 2b, and the metallized structure layer 3 has a first main side 3a and a second main side 3b. The transparent base plate layer 2 and the metallized structure layer 3 are mounted such that the second base main side 2b of the base plate layer 2 faces the first main side 3a of the metallized structure layer 3, where the main sides 2a, 2b; 3a, 3b are parallel to each other and are aligned with each other.

The UV blocking layer is positioned between the transparent base plate layer 2 and the metallized structure layer 3, these layers 2, 3, 6 being mounted to each other by means of a corresponding first adhesive layer 7 and second adhesive layer 8, the adhesive layers not being shown in FIG. 1 for reasons of clarity. The first adhesive layer 7 is positioned between the transparent base plate layer 2 and the UV blocking layer 6, and the second adhesive layer 8 is positioned between the UV blocking layer 6 and the metallized structure layer 3.

The protective layer 16 is arranged to protect the metallized structure layer 3, and is for example constituted by a durable plastic film. The protective layer 16 is adhered to the rest of the window arrangement 1 in any suitable way, for example by means of a third adhesive layer 17, the third adhesive layer not being shown in FIG. 1 for reasons of clarity.

All layers mounted together form the window arrangement 1 which is transparent, since the layers are formed by transparent materials. The metallic structure layer 3 comprises a metallic structure and a carrier 9, for example a plastic film, onto which the metallic structure is deposited, the metallic structure having a thickness and composition that makes it transparent.

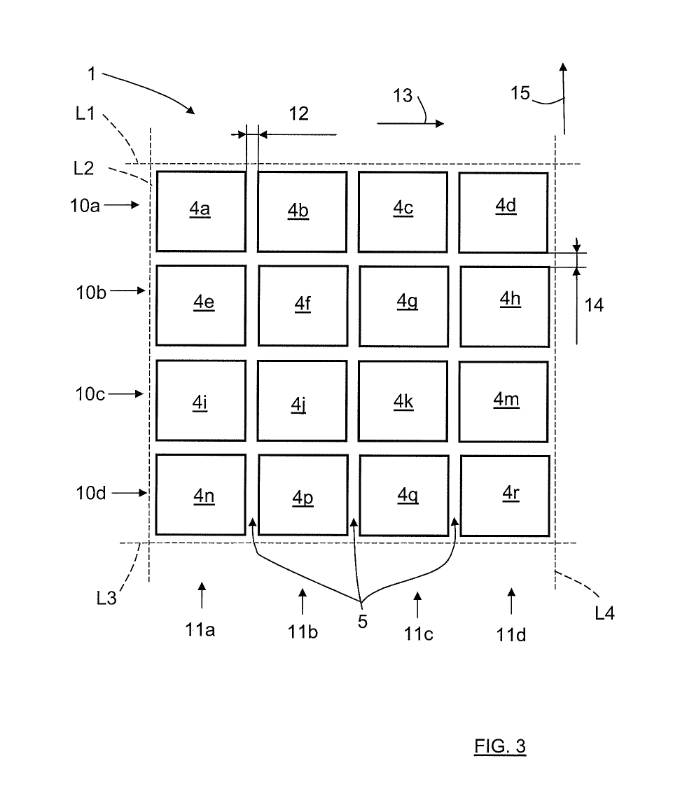

According to the present invention, with reference to FIG. 3 showing a part of the metallized structure layer 3, the metallic structure of the metallized structure layer 3 comprises a plurality of metallic areas 4; 4a, 4b, 4c, 4d, 4e, 4f, 4g, 4h, 4i, 4j, 4k, 4m, 4n, 4p, 4q, 4r separated by a coherent aperture 5 forming a grid in which the metallic areas 4; 4a, 4b, 4c, 4d, 4e, 4f, 4g, 4h, 4i, 4j, 4k, 4m, 4n, 4p, 4q, 4r are positioned.

The purpose of the metallized structure layer 3 is to reduce heat and/or UV radiation through the window arrangement 1 while mainly letting visible light through, in other words to block or at least attenuate frequencies above a first certain frequency but being transparent or semitransparent to frequencies below a second certain frequency. The first certain frequency is typically much higher than the second certain frequency. For example, the first certain frequency being associated with UV radiation and infrared light, has wavelengths in the order of micrometers, and wireless systems for mobile communication has wavelengths in the order of centimeters.

According to a first example, the metallic areas 4; 4a, 4b, 4c, 4d, 4e, 4f, 4g, 4h, 4i, 4j, 4k, 4m, 4n, 4p, 4q, 4r have a rectangular shape and are arranged in a two-dimensional array pattern with rows 10a, 10b, 10c, 10d and columns 11a, 11b, 11c, 11d. Adjacent metallic areas are separated by a first distance 12 in a first direction 13 and by a second distance 14 in a second direction 15, where the first direction 13 and the second direction 15 are mutually perpendicular. The metallic areas 4; 4a, 4b, 4c, 4d, 4e, 4f, 4g, 4h, 4i, 4j, 4k, 4m, 4n, 4p, 4q, 4r are thus quadrilateral in shape and evenly spaced apart in two dimensions.

As an example of possible sizes of the metallic areas 4; 4a, 4b, 4c, 4d, 4e, 4f, 4g, 4h, 4i, 4j, 4k, 4m, 4n, 4p, 4q, 4r and the first distance 12 and the second distance 14, the metallic areas 4; 4a, 4b, 4c, 4d, 4e, 4f, 4g, 4h, 4i, 4j, 4k, 4m, 4n, 4p, 4q, 4r may have sides which are about 2-4 mm long, and the first distance 12 and the second distance may be about 0.001-0.01 mm. The need for a precise design of the metallized structure layer 3 is eliminated as long as the elements are kept small enough, taking a dielectric constant and material thicknesses into account not being necessary, due to the broad-banded nature of the metallized structure layer 3. Further, the metallized structure layer 3 is preferably configured so that no negative visible impact is noticed when observed at a given distance.

For reasons of clarity, only a few metallic areas 4 shown in FIG. 1 are indicated with reference number, although it should be understood that the reference number 4 refers to all metallic areas 4 on the metallized structure layer 3. This is also the case for the coherent aperture 5, which only partly is indicated with reference number in FIG. 1. Furthermore, it is to be understood that the metallic areas 4 shown in FIG. 1 only are to be interpreted as a schematic indication of the presence of the metallic areas, not being indicative of sizes or distances.

In the same way, the metallic areas 4a, 4b, 4c, 4d, 4e, 4f, 4g, 4h, 4i, 4j, 4k, 4m, 4n, 4p, 4q, 4r shown in FIG. 3 are only to be interpreted as a schematic indication of a relatively small part of the metallized structure layer 3, as indicated by dash-dotted lines L1, L2, L3, L4 not being indicative of sizes or distances. There may be several thousands of metallic areas in a metallized structure layer 3 used in one window arrangement 1 according to the present invention.

The metallic areas 4; 4a, 4b, 4c, 4d, 4e, 4f, 4g, 4h, 4i, 4j, 4k, 4m, 4n, 4p, 4q, 4r have such dimensions that they are resonant for a certain frequency of incident electromagnetic radiation, such that they at least partially are transparent for incident electromagnetic radiation having a frequency below said certain frequency.

The resonant frequency is determined by size of the metallic areas 4; 4a, 4b, 4c, 4d, 4e, 4f, 4g, 4h, 4i, 4j, 4k, 4m, 4n, 4p, 4q, 4r. The smaller a metallic area 4; 4a, 4b, 4c, 4d, 4e, 4f, 4g, 4h, 4i, 4j, 4k, 4m, 4n, 4p, 4q, 4r is, the higher is its resonant frequency. The metallic areas 4; 4a, 4b, 4c, 4d, 4e, 4f, 4g, 4h, 4i, 4j, 4k, 4m, 4n, 4.p, 4q, 4r can be placed arbitrarily close to each other and can thus be covering most of the area of the metallic layer without blocking low frequencies and still maintaining the blocking function for IR and UV.

The present invention relates to the metallized structure layer 3 in itself as being intended to be mounted such that the first main side 3a of the metallized structure layer 3 faces the second base main side 2b of the transparent base plate layer 2, where the main sides 2b; 3a, 3b are parallel to each other and at least partly overlap.

The present invention also relates to the window arrangement 1 which in its least complicated form comprises the transparent base plate layer 2 and the metallized structure layer 3.

The present invention is not limited to the examples above, but may vary freely within the scope of the appended claims. For example, the metallic areas may have any other suitable shape such as oval, hexagonal or octagonal, where both density and shape of the metallic areas may vary over the metallized structure layer 3.

The metallized structure layer 3 can be formed by etching away portions of a uniform metal sheet to form the separated metallic patches, the removed portions forming the coherent aperture 5 according to the above.

The metallized structure layer 3 may only comprise metallic areas 4; 4a, 4b, 4c, 4d, 4e, 4f, 4g, 4h, 4i, 4j, 4k, 4m, 4n, 4p, 4q, 4r, not needing any carrier 3. In this case, the metallic areas 4; 4a, 4b, 4c, 4d, 4e, 4f, 4g, 4h, 4i, 4j, 4k, 4m, 4n, 4p, 4q, 4r are intended for direct application onto another layer comprised in the window arrangement, for example the transparent base plate layer 2 or the UV blocking layer 6, depending on which layers that are used and in which order they are applied. Also, in this case, the first main side 3a and the second main side 3b of the metallized structure layer 3 refer to imaginary planes coinciding with the different main sides of the metallic areas 4; 4a, 4b, 4c, 4d, 4e, 4f, 4g, 4h, 4i, 4j, 4k, 4m, 4n, 4p, 4q, 4r.

The window arrangement 1 may comprise more than the layers shown, for example the metallized structure layer 3 may be embedded in further not shown plastic layers for protective reason. When applicable, other layers, such as the UV blocking layer 6, may also be embedded in further not shown plastic layers. The order of the layers may also be of any suitable kind.

Although specific terms may be employed herein, they are used in a generic and descriptive sense only and not for purposes of limitation.

1. A metallized structure layer, comprising:
a first plurality of metallic areas arranged in a line, thereby forming a first column of metallic areas, the first plurality of metallic areas being further arranged such that each metallic area in the first column of metallic areas is spaced apart from its directly neighboring metallic area in the first column, wherein there is no metallic material located between any two directly neighboring metallic areas in the first column;
a second plurality of metallic areas arranged in a line, thereby forming a second column of metallic areas, the second plurality of metallic areas being further arranged such that each metallic area in the second column of metallic areas is spaced apart from its directly neighboring metallic area in the second column, wherein there is no metallic material located between any two directly neighboring metallic areas in the second column;
a third plurality of metallic areas arranged in a line, thereby forming a third column of metallic areas, the third plurality of metallic areas being further arranged such that each metallic area in the third column of metallic areas is spaced apart from its directly neighboring metallic area in the third column, wherein there is no metallic material located between any two directly neighboring metallic areas in the third column;
a fourth plurality of metallic areas arranged in a line, thereby forming a fourth column of metallic areas, the fourth plurality of metallic areas being further arranged such that each metallic area in the fourth column of metallic areas is spaced apart from its directly neighboring metallic area in the fourth column, wherein there is no metallic material located between any two directly neighboring metallic areas in the fourth column, wherein
the second column is parallel with the first column and spaced apart from the first column and there is no electrically conductive material located between the second column and the first column,
the second column is parallel with the third column and spaced apart from the third column and there is no electrically conductive material located between the second column and the third column,
the third column is parallel with the fourth column and spaced apart from the fourth column and there is no electrically conductive material located between the third column and the fourth column,
the metallized structure layer attenuates frequencies above a first frequency,
and
the metallized structure layer is substantially transparent to frequencies below a second frequency.

2. The metallized structure layer according to claim 1, wherein when the metallized structure layer is mounted, it is comprised in a window arrangement.

3. The metallized structure layer according to claim 1, wherein the metallized structure layer comprises a carrier onto which the metallic areas are deposited.

4. The metallized structure layer according to claim 1, wherein the metallic areas are made by a metallic oxide and are transparent to visible light.

5. The metallized structure layer according to claim 4, wherein the metallic areas have such dimensions that they are resonant for a certain frequency of incident electromagnetic radiation, such that they at least partially are transparent for incident electromagnetic radiation having a frequency below said certain frequency.

6. The metallized structure layer according to claim 1, wherein the metallic areas have a rectangular shape.

7. The metallized structure layer according to claim 6, wherein the metallic areas are arranged in a two-dimensional array pattern with rows and columns, adjacent metallic areas being separated by a first distance in a first direction and by a second distance in a second direction, the first direction and second direction being mutually perpendicular.

8. A window arrangement, comprising:
a transparent base plate layer; and
a metallized structure layer, wherein
the base plate layer has a first base main side and a second base main side,
the metallized structure layer has a first main side and a second main side,
the transparent base plate layer and the metallized structure layer are mounted such that the second base main side of the base plate layer faces the first main side of the metallized structure layer, wherein said main sides are parallel to each other and at least partly overlap, and
the metallized structure layer comprises:
a first plurality of metallic areas arranged in a line, thereby forming a first column of metallic areas, the first plurality of metallic areas being further arranged such that each metallic area in the first column of metallic areas is spaced apart from its directly neighboring metallic area in the first column, wherein there is no metallic material located between any two directly neighboring metallic areas in the first column;
a second plurality of metallic areas arranged in a line, thereby forming a second column of metallic areas, the second plurality of metallic areas being further arranged such that each metallic area in the second column of metallic areas is spaced apart from its directly neighboring metallic area in the second column, wherein there is no metallic material located between any two directly neighboring metallic areas in the second column;
a third plurality of metallic areas arranged in a line, thereby forming a third column of metallic areas, the third plurality of metallic areas being further arranged such that each metallic area in the third column of metallic areas is spaced apart from its directly neighboring metallic area in the third column, wherein there is no metallic material located between any two directly neighboring metallic areas in the third column;
a fourth plurality of metallic areas arranged in a line, thereby forming a fourth column of metallic areas, the fourth plurality of metallic areas being further arranged such that each metallic area in the fourth column of metallic areas is spaced apart from its directly neighboring metallic area in the fourth column, wherein there is no metallic material located between any two directly neighboring metallic areas in the fourth column, wherein
the second column is parallel with the first column and spaced apart from the first column and there is no electrically conductive material located between the second column and the first column,
the second column is parallel with the third column and spaced apart from the third column and there is no electrically conductive material located between the second column and the third column,
the third column is parallel with the fourth column and spaced apart from the fourth column and there is no electrically conductive material located between the third column and the fourth column,
the metallized structure layer attenuates frequencies above a first frequency,
and
the metallized structure layer is substantially transparent to frequencies below a second frequency.

9. The window arrangement according to claim 8, further comprising a UV blocking layer that is between the second base main side and the first main side.

10. The window arrangement according to claim 9, further comprising:
an adhesive adhering the UV blocking layer to the transparent base plate layer; and
an adhesive adhering the UV blocking layer to the metallized structure layer.

11. The window arrangement according to claim 8, wherein the metallized structure layer comprises a carrier onto which the metallic areas are deposited.

12. The window arrangement according to claim 8, wherein the metallic areas are made by a metallic oxide and are transparent.

13. The window arrangement according to claim 8, wherein the metallic areas have such dimensions that they are resonant for a certain frequency of incident electromagnetic radiation, such that they at least partially are transparent for incident electromagnetic radiation having a frequency below said certain frequency.

14. The window arrangement according to claim 8, wherein the metallic areas have a rectangular shape.

15. The window arrangement according to claim 14, wherein the metallic areas are arranged in a two-dimensional array pattern with rows and columns, adjacent metallic areas being separated by a first distance in a first direction and by a second distance in a second direction, the first direction and second direction being mutually perpendicular.
